(19) United States
(12) Patent Application Publication
(10) Pub. No.: US 2011/0307287 A1
(43) Pub. Date: Dec. 15, 2011

(54) Meeting cost effectiveness planning tool

(76) Inventor: Reginald Conley, Castro Valley, CA (US)

(21) Appl. No.: 13/067,606

(22) Filed: Jun. 13, 2011

Related U.S. Application Data
(60) Provisional application No. 61/354,253, filed on Jun. 14, 2010.

(51) Int. Cl. G06Q 10/00

(52) U.S. Cl. 705/7.19

(57) ABSTRACT

This invention relates to a method by which any individual or organization can associate, record, track and manage meeting events against cost and associated meeting effectiveness. Cataloging key cost factors such as meeting frequency, participant hours, discipline of participants, participant wages, required travel and travel hours, punctuality and number of participants. As described herein, the name given to this invention is a Meeting Cost Effectiveness Planning Tool.

### BRIEF DESCRIPTION OF THE DRAWINGS

FIG. 1—Functional System Blocks

FIG. 2—Meeting Capture Flow Chart

FIG. 3—Sample Meeting Capture page.

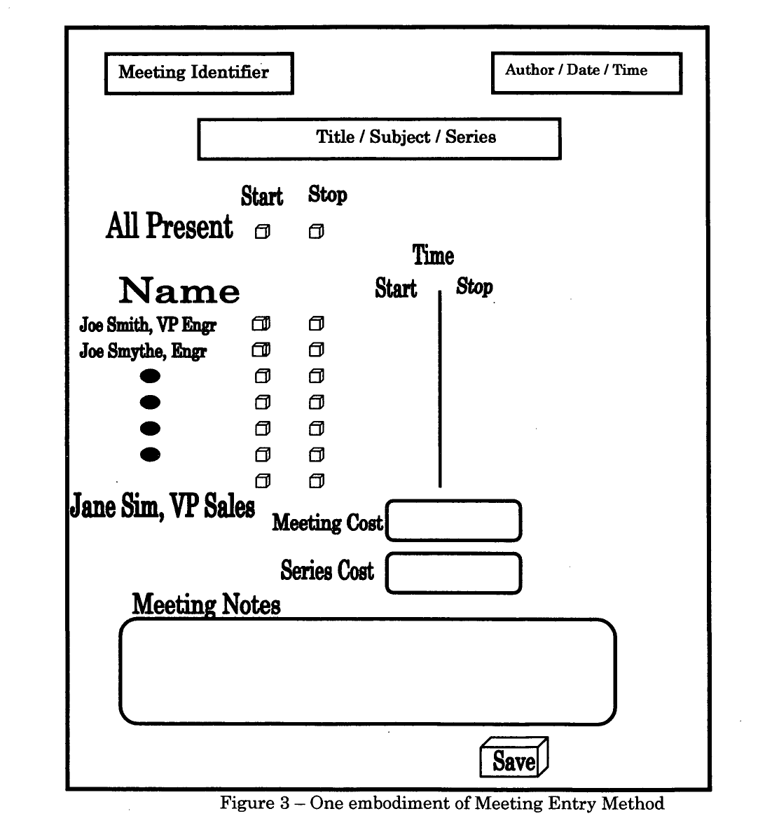

This application is based on the provisional application Ser. No. 61/354,253, filed Jun. 14, 2010.

### DETAILED SPECIFICATION OF THE INVENTION

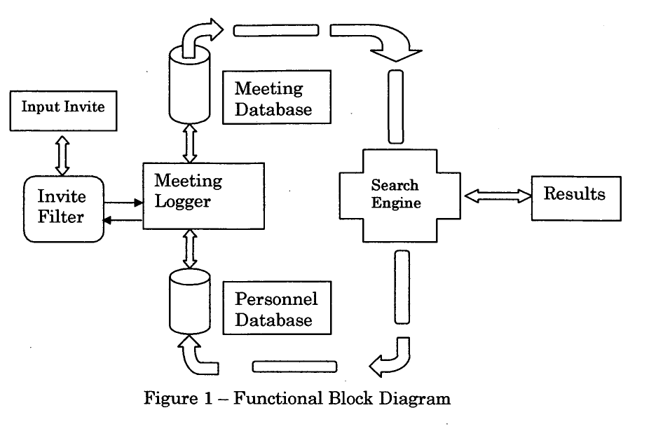

The embodiment of this invention is a tool to align associated participant salaries and costs with meeting effectiveness. As described in FIG. 1, step 1, the tool accepts any of several meeting notification input formats, such as Microsoft Outlook and associates a cost basis as a function of the meeting participation. In the case where travel is required by any participant member, a placeholder is reserved for tracking those hours and costs.

In one method of invocation, the tool user (i.e. meeting initiator or a meeting invitee) forwards or copies via the cc list, the meeting invitation-to the software tool alias. As shown in FIG. 1, the input filter accepts the meeting invitation and scans the form for meeting information and participant list. (Target search items include tool user, meeting initiator, meeting participants, special items such as travel, company affiliation, email address, meeting name/subject, time, series definitions). The meeting filter then passes this information to the meeting logger for meeting and participant classification. The meeting logger, utilizing the meeting database, determines if the meeting is a new or previously established series or single event. The logger, using the personnel database, also determines if each participant is categorized, and assigned an estimated cost basis, i.e. salary or hourly wage. (This could include special provisioning for conditions such as travel hours for participation.). Based on meeting and participant status (i.e. new or unclassified participants) the logger will return to the tool user (via the input filter) a meeting log track file for use once the meeting has begun. The meeting logger also updates the system database. In the event the meeting tracking file indicates there are participants without an associated cost basis, the tool user is queried to update the participants. As a second example, a meeting for which participants have a documented location alternate from the meeting initiator, but no alternative conferencing methods are noted (i.e., no conference call number in the meeting request), a notification will be sent to the tool user requesting if associated travel time/cost should be appended.

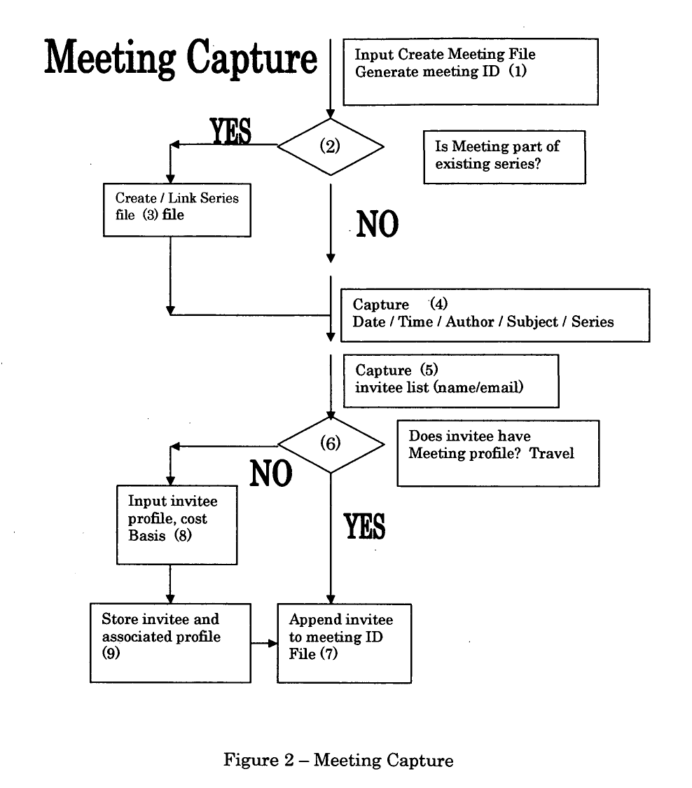

In the event the meeting tracking file indicates there are participants without an associated cost basis or travel expectation, the tool user is queried to update participants. As shown in FIG. 2, the participant “Jane Sim, VP of Sales” is highlighted in an alternate manner, indicating that is participant is not is not properly cost classified. By selecting the participant name, an embedded cost estimation field opens within the form for editing. The tool user can update an estimates cost basis for this individual and return the modified form at the close of the prescribed meeting. Selecting an individual from the meeting list brings up the associated cost and travel estimation. Changing the cost basis will result in alternate calculations for any subsequent meetings. For a meeting that is part of a series, each time the user submits a completed meeting participant file, a new file is returned to the user (until such time as the meeting series is terminates or the tool user removes themselves from the meeting form and submits it).

In the case of the enterprise usage, the company administrator keeps a personnel log. If, in the event of a meeting notice for which the cost/travel profile of a company participant is not within the database, the administrator is notified to provide the correct cost basis. In the enterprise edition, only the meeting initiator ( or designee) is provided a meeting form to used at the time of meeting commencement. Cost data is provided based on administration rights and configuration. By virtue of administrator designation access to meeting cost, individual salaries, meeting series cost, travel costs, etc, can be kept secure. In the case of a meeting series, meetings are terminated based upon a closure designation by the meeting originator.

Depending upon the tool embodiment (personal or enterprise) the meeting and personnel database can be either local to the user (personal) or central for corporate use (enterprise). In the personal embodiment, users other than the meeting originator can forward a meeting invite into their copy of the tool and become a user. As such, they will be able to assign and retrieve costs and use all features associated with the personal version. In the enterprise version, company executives can use their access to this information to evaluate overall corporate meeting effectiveness and the proper use of meeting hours, personnel use, program association and costs as related to outcome.

I claim:

1. Software tool which tracks, records and document meeting title, attendees and associated attendee costs, i.e., travel time and cost, wages or other compensatory metric(s). Components of the tool include, but are not restricted to the following elements;

2. A means to read and import meeting invitee listings into the software tool.

3. A means where by each meeting invitee can be assigned a location, title, and associated cost basis estimated by the user and that associated assignment record maintained for subsequent (and alternate) meeting invitations.

4. A means by which a list of records including, but not limited to meeting type, meeting initiation, meeting closure, duration, series definition, members requiring travel (and estimated time/cost), participant confirmation, late participation, early withdrawal, aggregate cost—all of which being recorded and tracked.

5. A means by which, but not limited to, automatic cataloging of meeting title, date, time, meeting type, recurring series alignment, initiator, and cost is recorded and stored for simple recollection, data mining, and search.

6. A means by which subsequent notes on meeting results can be appended to individual meeting and/or series so as to keep an inclusive record of related outcomes associated with costs.

7. A means by which the ability to import, extract and display comparable Meeting Data from other tool initiators/databases.

8. The tool shall also allow for a meeting author to manually enter meeting participants, times, series information, location, etc and access the database so as to get an estimate of associated costs before officially scheduling the meeting.

9. For alternate embodiments, a means where by actual salary/cost data, title, grade and location can be imported and associated with each member within the organization. This embodiment is envisioned for corporate use.

10. In the alternate embodiment described in claim number 9, the tool shall provide a means/mechanism in which visibility to cost records and subsequent meeting costs can be restricted by the organization/administrator.

11. For this alternate embodiment of claim 9, a means by which the software tool can either accept meeting initiator inputs only and/or accept multiple records of the same meeting and use a priority tree so as to which input to accept as the official cost record.

12. Per claim 11, a means to assign and store priority ranking to organizational members, as needed, for purpose of selecting the official meeting record when multiple entries are present.

13. Per the alternate embodiment of claim 9, a means to aggregate all meetings within an organization and output a real time record of organizational meeting costs (i.e. real time display of meeting cost for ‘ticker tape’ updating to executive staff).

14. Per the alternate embodiment of claim 9, tool will allow alternative methods of automatic participant tracking (such as, but not limited to, badge RFID, wireless, teleconference user ID, or barcode) for participant entry, exit and meeting start/stop confirmation.

15. Per the alternate embodiment of claim 9, the tool will allow authorized meeting authors the ability to manually enter meeting participant, time, series, etc, per claim 8, so as to get an accurate meeting cost basis before officially scheduling a meeting.
